(19) United States
(12) Patent Application Publication
(10) Pub. No.: US 2009/0286693 A1
(43) Pub. Date: Nov. 19, 2009

(54) MICROARRAYS OF TAGGED COMBINATORIAL TRIAZINE LIBRARIES

(75) Inventors: Young-Tae CHANG, Singapore (SG); Ho-Sang Moon, Gyeonggi-do (KR)

Correspondence Address: BROWDY AND NEIMARK, P.L.L.C.;624 NINTH STREET, NW, SUITE 300, WASHINGTON, DC, 20001-5303, US

(73) Assignee: New York University, NYU Medical Center, Department of Industrial Liaison, New York, NY (US)

(21) Appl. No.: 12/469,517

(22) Filed: May 20, 2009

Related U.S. Application Data
(63) Continuation-in-part of application No. 10/267,044, filed on Oct. 9, 2002, now abandoned.
(60) Provisional application No. 60/339,294, filed on Dec. 12, 2001.

(51) Int. Cl. C40B 30/04; C40B 40/04

(52) U.S. Cl. 506/9; 506/15

(57) ABSTRACT

Triazine linkers can be used to prepare universal small molecule chips for functional proteomics and sensors. These triazine linker compounds are prepared by making a first building block by adding a first amine by reductive amination of triazine, making a second building block by adding a second amine to cyanuric chloride, and combining the first and second building blocks by aminating the first building block onto one of the chloride positions of the second building block. These triazine linkers are then linked to a substrate for determining binding affinity of proteins.

### CROSS-REFERENCE TO RELATED APPLICATION

The present application is a continuation in part of Ser. No. 10/267,044, filed Oct. 9, 2002, which claims priority from non-provisional application Ser. No. 60/339,294, filed Dec. 12, 2001, the entire contents of each of which are hereby incorporated by reference.

### FIELD OF THE INVENTION

The present invention relates to microarrays containing tagged triazine libraries which can be used as universal small molecule chips for functional proteomics and sensors.

### BACKGROUND OF THE INVENTION

The Human Genome Project provided a huge amount of sequence data for dozens of thousands of genes. Elucidating the function of each gene (so-called functional genomics) is the next step in the challenge of understanding human genetics¹. Conventionally, geneticists have investigated the function of unknown genes by comparing normal phenotypes with knock-out or over-expression of the target gene, based on the assumption that the phenotypic difference is closely related to the function of the target gene. Recent developments in RNAi² and antisense techniques³ have make it possible to temporarily turn off given gene expression by targeting mRNA rather than the DNA genome itself.

A novel approach using chemical library screening to find an interesting phenotypic change by targeting specific gene products, that is, proteins, has emerged as an alternative tactic; this is called chemical genetics⁴. In chemical genetics, one chemical compound may specifically inhibit or activate one target protein (for purposes of illustration, called “protein A”). Thus, the compound is equivalent to the gene knock-out or over-expression of the corresponding gene A, as in conventional genetics.

Combinatorial library techniques⁵ facilitate the synthesis of many molecules. These techniques can be combined with high throughput screening (HTS) to screen many compounds to discover a novel, small molecule in the first step of chemical genetics study. Once one finds an intriguing small molecule, here referred to as “molecule A”, that induces a novel phenotype in cells or in an embryonic system, the next step is to identify the target protein and the biochemical pathways involved. An affinity matrix on bead or a tagged molecule (photoaffinity, chemical affinity, biotin or fluorescence) obtained by modifying molecule A, is commonly used for identifying the target protein. The target can be fished out by binding affinity of the proteins to the immobilized molecule, followed by separation on gel and sequencing by tandem mass spectrometry (MS-MS) technique. As the affinity matrix isolation usually gives multiple proteins, including non-specific binders, it is best to compare the gel results with those of control matrices side by side. Desirable control matrices will be obtained from structurally similar, molecules to molecule A which are inactive. The proteins that bind only to the active affinity matrix, without binding to the control matrices, are promising target candidates. The candidate proteins are then purified and screened in vitro with molecule A to confirm that the isolated protein is truly protein A.

As a whole, successful chemical genetics work will identify a novel gene product (i.e., protein A), and its on or off switch, small molecule pairs. By analyzing the phenotype change, the function of protein A, which is the expression product of gene A, will be discerned. At the same time, the identified small molecule key, molecule A, is a useful biochemical tool to regulate the pathway of protein A, and may be a promising drug candidate as well.

Unfortunately, the current approach of chemical genetics intrinsically contains a very difficult step, that of modifying molecule A into an affinity molecule. In order to add a linker to molecule A without adversely affecting its activity, a thorough structure-activity relationship (SAR) study of molecule A is required to find a proper site for linker addition. This site is probably a site of molecule A exposed to the solvent direction from a binding pocket in protein A. This procedure is, in many cases, extremely cumbersome, and sometimes is even completely impossible.

### SUMMARY OF INVENTION

It is an object of the present invention to provide tagged combinatorial triazine libraries that can be used for chemical genetics.

It is another object of the present invention to provide an improved method for chemical genetics.

It is a further object of the present invention to synthesize linker libraries by combinatorial methods for screening in phenotypic assays.

The present invention comprises a method for chemical genetics using library molecules carrying a linker (LL: library with linker) from the first step of the procedure. In this method, LL is synthesized by combinatorial methods and screened in phenotypic assays. The selected active compounds are directly linked to resin beads or to a tagging moiety without further SAR study using the already existing linker. Eliminating the requirement for structure-activity relationship determination dramatically accelerates the connection of function screening to the affinity matrix step. This reduces the assay time from months to days, making the chemical genetics approach much more practical and powerful than it has been heretofore.

### BRIEF DESCRIPTION OF DRAWINGS

FIG. 1 shows examples of triazine-linker compounds.

FIG. 2 shows a conventional synthetic pathway of triazine library by solution chemistry.

FIG. 3 shows an orthogonal solid phase synthesis pathway for the triazine library with linker according to the present invention.

FIG. 4 illustrates synthesis of building blocks according to the present invention.

FIG. 5 shows syntheses of triazine compound with linker.

FIG. 6 illustrates agarose bead synthesis of the triazine derivatives of the present invention.

FIG. 7 shows NHS-derivatized slides with 2688 triazine compounds spotted in duplicates and probed with human IgG-Cy3.

### DETAILED DESCRIPTION OF THE INVENTION

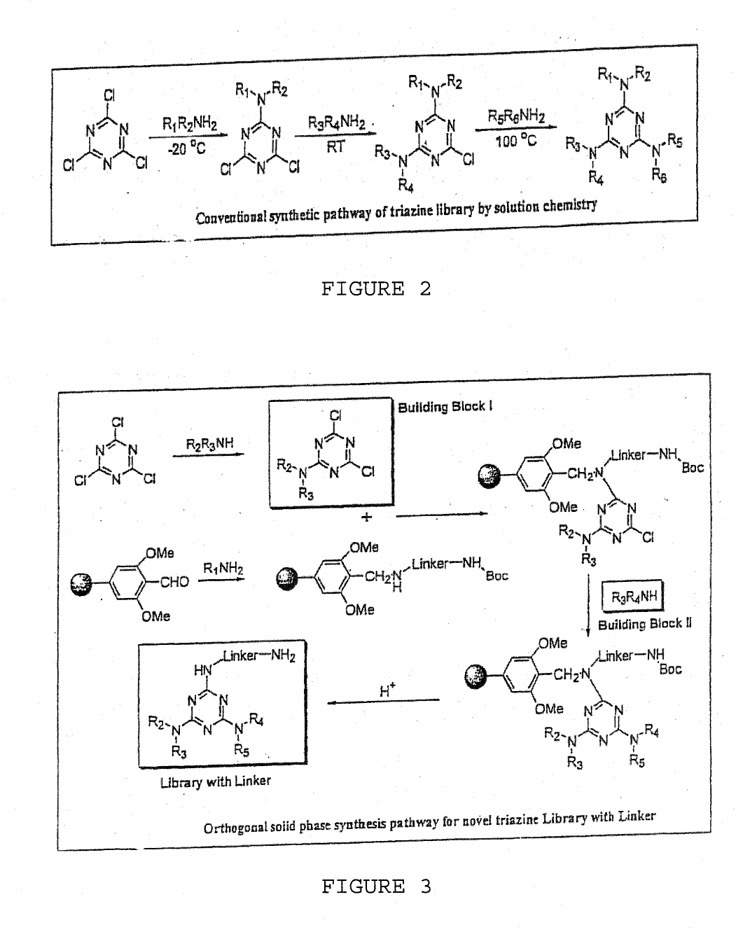

Triazine is used as the linker library scaffold. Triazines are used because they are structurally similar to purine and pyrimidine, and they have demonstrated their biological potentials in many applications. In particular, triazines have many drug-like properties, including molecular weight of less than 500, cLogP of less than 5, etc. As the triazine scaffold has three-fold symmetry, the modification is also highly flexible and able to generate diversity. Furthermore, the starting material, triazine trichloride, and all of the required building blocks, which are amines, are relatively inexpensive. Because if its ease of manipulation and the low price of the starting material, triazine has elicited much interest as an ideal scaffold for a combinatorial library, resulting in several triazine libraries having been published in the literature⁷. However, all of the reported library synthesis procedures, both for solid and solution phase chemistry, are based on sequential aminations using the reactivity differences of the three reaction sites. This is shown in FIG. 2, the conventional synthetic pathway of a triazine library by solution chemistry.

In this conventional method, the first substitution occurs at low temperatures while the second and third reactions require subsequently higher temperatures. This stepwise amination approach, however, is difficult to generalize for nucleophiles having differing reactivities. Thus, they may generate many byproducts together with the desired product. Substituted cyanuric dichloride moiety was loaded onto a TGlinker-functionalized resin, whereas previously, a linker mono-substituted (the linker as the first substituent) cyanuric dichloride was loaded onto the resin as the first step in the solid-phase synthesis (Scheme 1). This TG-linker-functionalized resin allows for rapid library diversification through simple splitting of the resin. As a consequence of the altered scheme, the second and more important improvement is the addition of primary alcohols to the library building block palette that were unattainable with our previous approach. Primary alcohols may only be efficiently and cleanly added to the cyanuric chloride scaffold as the first (of three) substitutions. This is due to the drastic decrease in reactivity seen with substituted cyanuric chloride analogues. Introducing an alcohol moiety as the first substituent, thus forming a building block II which can be subsequently loaded to a TG-linker-functionalized resin, is a very useful addition to our chemical toolbox and allows for N versus O atom substitution comparisons with hit compounds in later studies. The general tagged linker strategy is advantageous for a number of additional reasons. The basic linker used in all.

Scheme 1. General Synthetic Scheme for Construction of TG Triazine Library B Uttamchandani et al. Journal of Combinatorial Chemistry cases, 2,2-[1,2-ethanediyl-bis(oxy)]bisethanamine, is commercially available and affordable and is easily monoprotected (N-Boc) in one step. Compound cleavage from the resin and linker deprotection is accomplished simultaneously in one step. The linker provides a sufficient space between the compounds and the microarray surface, at the same time allowing for greater conformational flexibility in the immobilized compounds. Furthermore, its hydrophilic character may provide a more protein-friendly environment during subsequent microarray screening processes. Last, the amino functional group allows for facile small-molecule immobilization and for a rapid transition to further downstream studies, such as affinity matrix pull-down experiments, without the need for any hit compound modification.

The compounds were spotted, in duplicates, as an SMM on a modified glass substrate derived from standard microscope slides in a deterministic fashion that ensures immediate high-fidelity locus-based identification (Scheme 2). In total, 5376 spots corresponding to 2688 triazine-based library compounds were printed; 1152 of those were TG compounds and were synthesized as reported herein, and 1536 compounds were synthesized as reported previously by our group. In addition, we included in our arrayed grids a dye reference to not only validate the slide derivatization process, but also appropriately home in the software in the subsequent data acquisition.

The present process solves the problem of byproducts using a straightforward synthetic pathway that can be used for the general preparation of a trisubstituted triazine library. The present process does not use selective amination, which requires careful monitoring of the reaction and purification steps. Instead, the present process uses three different kinds of building blocks to construct the library. The first amine (linker) is loaded onto an acid-labile aldehyde resin substrate such as by reductive amination mono- or di-methoxybenzaldehyde resins. The second amine is then added to cyanuric chloride to form a building bock with the dichlorotriazine core structure. These two building blocks are then combined by amination of the first building block onto one of the chloride positions of the second building block. Any sequential over-amination on the other chloride position is efficiently suppressed by physical segregation from any other amine available on the solid support. The third building block, which can be a primary or secondary amine, then reacts with the last chloride position to produce the trisubstituted triazine. Since all reactions are orthogonal to each other, no further purification is required after cleavage of the final compound, as shown in FIG. 3. Using this established synthetic scheme, a linker was introduced in the trisubstituted triazine library to synthesize thousands of library linker compounds in amounts of about 1-2 mg.

### Syntheses of Building Blocks

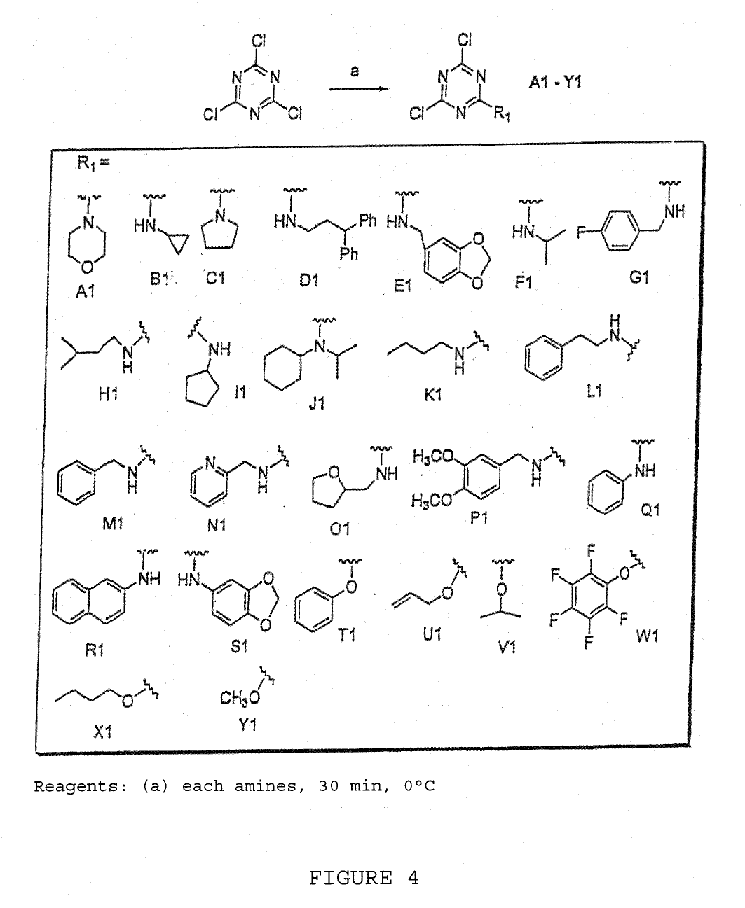

To a solution of 100 mg (0.543 mmole) cyanuric chloride, purchased from A cross Chemical Company, USA, and 0.05 ml DIEA, purchased from Aldrich Chemical Company, USA, in 5 ml anhydrous THF, purchased from Aldrich Chemical Company, USA, was added each amine or alcohol reagent (0.652 mmol, or 1.2 eq) at 0° C. The reaction mixture was stirred for 30 minutes at 0° C. After TLC checking, the reaction mixture was filtered and the solvent removed in vacuo. The compounds were purified by column chromatography. Each compound was identified by LC-MS (Agilent 1100 model). This scheme is shown in FIG. 4, and the identification of the building blocks is shown in Table 1.

TABLE 1
Identification of Building Blocks (A1-Y1)
The products were identified LC-MS (Agilent 1100 model)

| Comp. | Mass |
|---|---|
| ID | (m + 1) |
| A1 | 235 |
| B1 | 205 |
| C1 | 219 |
| D1 | 359 |
| E1 | 299 |
| F1 | 207 |
| G1 | 273 |
| H1 | 235 |
| 11 | 233 |
| J1 | 289 |
| K1 | 221 |
| L1 | 269 |
| M1 | 255 |
| N1 | 256 |
| O1 | 249 |
| P1 | 315 |
| Q1 | 241 |
| R1 | 291 |
| S1 | 285 |
| T1 | 242 |
| U1 | 206 |
| V1 | 208 |
| W1 | 332 |
| X1 | 222 |
| Y1 | 180 |

Syntheses of Triazine Library with Linker

To a solution of 1.0 g (1.1 mmole) PAL™-aldehyde resin, purchased from Midwest Bio-Tech, USA, was added 1.5 g (3.5 mmole) of Boc-linker (2-[2-amino-ethoxy-ethoxyethyl]-carbamic tert-butyl ester) in 50 ml anhydrous THF containing 10 ml of acetic acid at room temperature. The reaction mixture was stirred for one minute at room temperature and then 1.63 g (7.7 mmole, 7 eq) sodium triacetoxyborohydride was added. The reaction mixture was stirred for twelve hours and filtered. The resin was washed three times with DMF, three times with dichloromethane, three times with methanol, and three times with dichloromethane.

The next step was performed by general solid phase synthesis. To a solution of 1.0 g resin and 1 ml DIEA in 50 ml anhydrous THF at room temperature, amino-mono-substituted triazine compounds of a mono-alkoxy-substituted triazine (4 eq) was added. The reaction mixture was stirred for two hours at 60° C. and filtered. The resin was washed three times with DMF, three times with dichloromethane, three times with methanol, and three times with dichloromethane.

The final coupling step was performed by general solid phase synthesis. To the resin (10 mg) and 0.1 ml DIEA in 0.7 ml NMP was added 4 eq of each amine. The reaction mixture was stirred for two hours at 120° C. and filtered. The resin was washed three times with DMF, three times with dichloromethane, three times with methanol, and three times with dichloromethane. Resin cleavage was conducted using 10% trifluoroacetic acid in dichloromethane for 30 minutes at room temperature, after which the resin was washed with dichloromethane. The products were identified using LC-MS ((Agilent 1100 model).

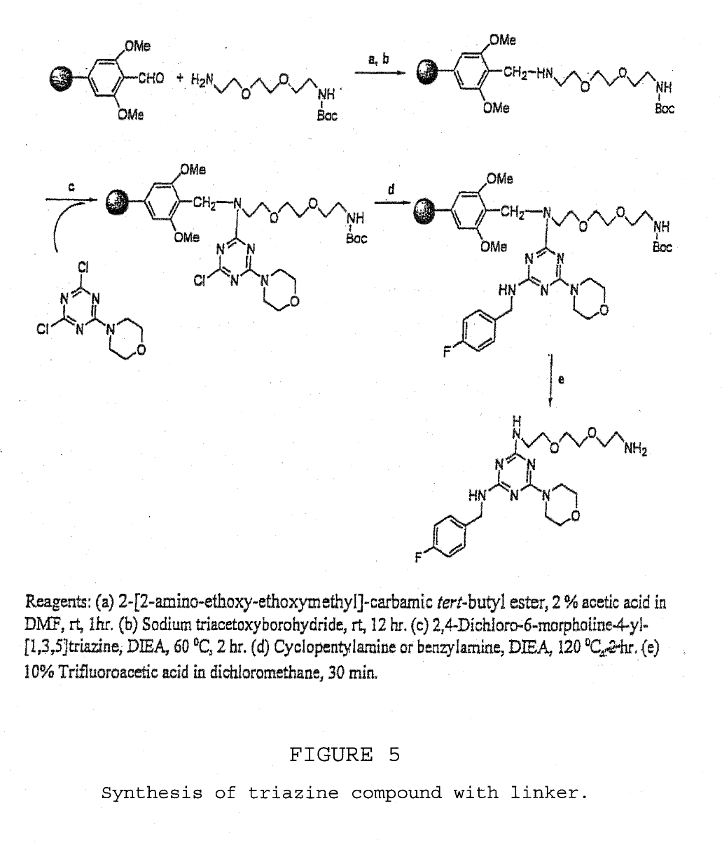

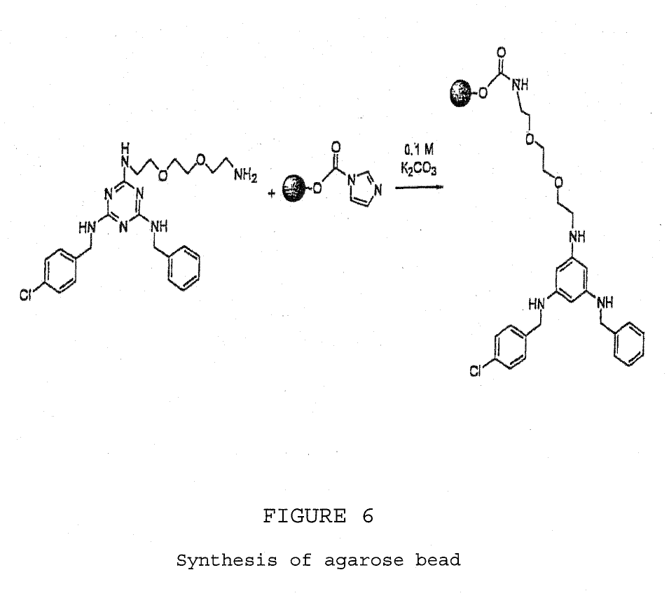

FIG. 5 illustrates syntheses of triazine compounds with linker. In this Figure, the reagents are:
a. 2-[2-amino-ethoxy-ethoxymethyl]-carbamic tert-butyl ester, 2% acetic acid in DMF, room temperature, one hour
b. sodium triacetoxyborobutyride, room temperature, for twelve hours
c. 2,4-dichloro-6-morpholine-4-yl-[1,3,5]-triazine, DIEA, at 60° C. for two hours
d. cyclopentylamine or benzylamine, DIEA, at 120° C. for two hours
e. 10% trifluoroacetic acid in dichloromethane for 30 minutes

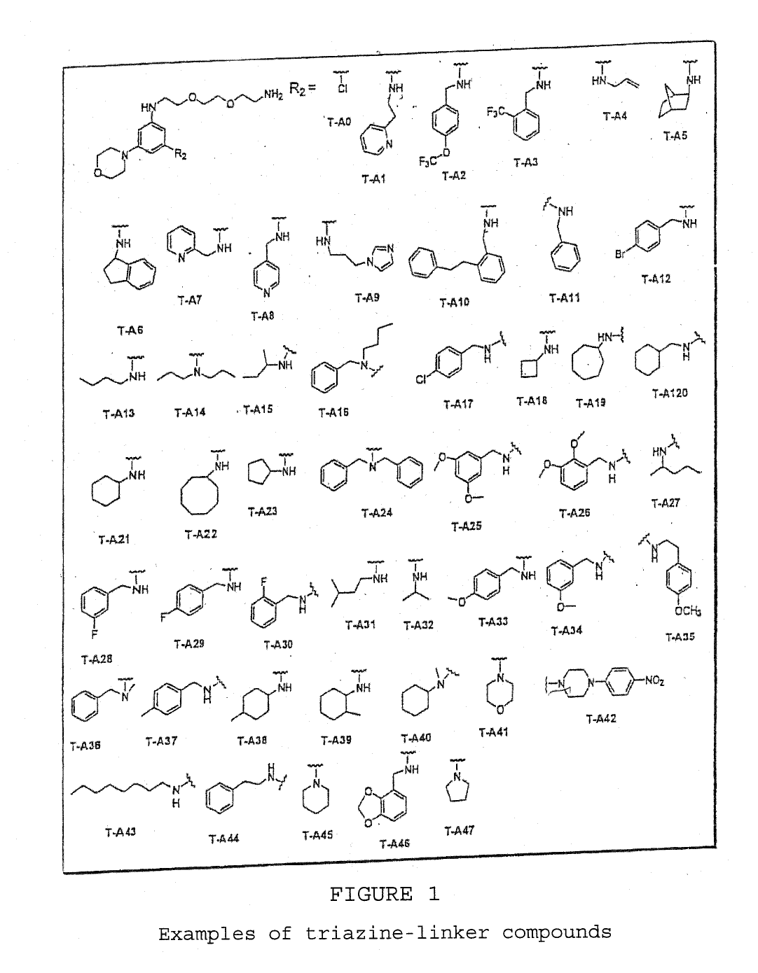

FIG. 1 illustrates examples of triazine-linker compounds. These examples are for purposes of illustration only, and are not intended to be limiting of the invention.

Table 2 illustrates compounds synthesized by the method of the present invention which were identified by LC-MS (Agilent 1100 model).

TABLE 2
Identification of Synthesized Compounds (with LC-MS).
The products were identified LC-MS (Agilent 1100 model).

| | R₁ | | | | | | | | | | | | |
|---|---|---|---|---|---|---|---|---|---|---|---|---|---|
| R₂ | A | B | C | D | E | F | G | H | I | J | K | L | M |
| 0 | 347 | 317 | 331 | 471 | 411 | 319 | 385 | 347 | 345 | 401 | 333 | 381 | 367 |
| 1 | 433 | 403 | 417 | 557 | 497 | 405 | 471 | 433 | 431 | 487 | 419 | 467 | 453 |
| 2 | 502 | 472 | 486 | 626 | 566 | 474 | 540 | 502 | 500 | 556 | 488 | 536 | 522 |
| 3 | 486 | 456 | 470 | 610 | 550 | 458 | 524 | 486 | 484 | 540 | 472 | 520 | 506 |
| 4 | 368 | 338 | 352 | 492 | 432 | 340 | 406 | 368 | 366 | 422 | 354 | 402 | 388 |
| 5 | 422 | 392 | 406 | 546 | 486 | 394 | 460 | 422 | 420 | 476 | 408 | 456 | 442 |
| 6 | 444 | 414 | 428 | 568 | 508 | 416 | 482 | 444 | 442 | 498 | 430 | 478 | 464 |
| 7 | 419 | 389 | 403 | 543 | 483 | 391 | 457 | 419 | 417 | 473 | 405 | 453 | 439 |
| 8 | 419 | 389 | 403 | 543 | 483 | 391 | 457 | 419 | 417 | 473 | 405 | 453 | 439 |
| 9 | 436 | 406 | 420 | 560 | 500 | 408 | 474 | 436 | 434 | 490 | 422 | 470 | 456 |
| 10 | 522 | 492 | 506 | 646 | 586 | 494 | 560 | 522 | 520 | 576 | 508 | 556 | 542 |
| 11 | 418 | 388 | 402 | 542 | 482 | 390 | 456 | 418 | 416 | 472 | 404 | 452 | 438 |
| 12 | 497 | 467 | 481 | 621 | 561 | 469 | 535 | 497 | 495 | 551 | 483 | 531 | 517 |
| 13 | 384 | 354 | 368 | 508 | 448 | 356 | 422 | 384 | 382 | 438 | 370 | 418 | 404 |
| 14 | 440 | 410 | 424 | 564 | 504 | 412 | 478 | 440 | 438 | 494 | 426 | 474 | 460 |
| 15 | 384 | 354 | 368 | 508 | 448 | 356 | 422 | 384 | 382 | 438 | 370 | 418 | 404 |
| 16 | 474 | 444 | 458 | 598 | 538 | 446 | 512 | 474 | 472 | 528 | 460 | 508 | 494 |
| 17 | 452 | 422 | 436 | 576 | 516 | 424 | 490 | 452 | 450 | 506 | 438 | 486 | 472 |
| 18 | 382 | 352 | 366 | 506 | 446 | 354 | 420 | 382 | 380 | 436 | 368 | 416 | 402 |
| 19 | 424 | 394 | 408 | 548 | 488 | 396 | 462 | 424 | 422 | 478 | 410 | 458 | 444 |
| 20 | 424 | 394 | 408 | 548 | 488 | 396 | 462 | 424 | 422 | 478 | 410 | 458 | 444 |
| 21 | 410 | 380 | 394 | 534 | 474 | 382 | 448 | 410 | 408 | 464 | 396 | 444 | 430 |
| 22 | 438 | 408 | 422 | 562 | 502 | 410 | 476 | 438 | 436 | 492 | 424 | 472 | 458 |
| 23 | 396 | 366 | 380 | 520 | 460 | 368 | 434 | 396 | 394 | 450 | 382 | 430 | 416 |
| 24 | 508 | 478 | 492 | 632 | 572 | 480 | 546 | 508 | 506 | 562 | 494 | 542 | 528 |
| 25 | 478 | 448 | 462 | 602 | 542 | 450 | 516 | 478 | 476 | 532 | 464 | 512 | 498 |
| 26 | 478 | 448 | 462 | 602 | 542 | 450 | 516 | 478 | 476 | 532 | 464 | 512 | 498 |
| 27 | 398 | 368 | 382 | 522 | 462 | 370 | 436 | 398 | 396 | 452 | 384 | 432 | 418 |
| 28 | 436 | 406 | 420 | 560 | 500 | 408 | 474 | 436 | 434 | 490 | 422 | 470 | 456 |
| 29 | 436 | 406 | 420 | 560 | 500 | 408 | 474 | 436 | 434 | 490 | 422 | 470 | 456 |
| 30 | 436 | 406 | 420 | 560 | 500 | 408 | 474 | 436 | 434 | 490 | 422 | 470 | 456 |
| 31 | 398 | 368 | 382 | 522 | 462 | 370 | 436 | 398 | 396 | 452 | 384 | 432 | 418 |
| 32 | 370 | 340 | 354 | 494 | 434 | 342 | 408 | 370 | 368 | 424 | 356 | 404 | 390 |
| 33 | 448 | 418 | 432 | 572 | 512 | 420 | 486 | 448 | 446 | 502 | 434 | 482 | 468 |
| 34 | 448 | 418 | 432 | 572 | 512 | 420 | 486 | 448 | 446 | 502 | 434 | 482 | 468 |
| 35 | 462 | 432 | 446 | 586 | 526 | 434 | 500 | 462 | 460 | 516 | 448 | 496 | 482 |
| 36 | 432 | 402 | 416 | 556 | 496 | 404 | 470 | 432 | 430 | 486 | 418 | 466 | 452 |
| 37 | 432 | 402 | 416 | 556 | 496 | 404 | 470 | 432 | 430 | 486 | 418 | 466 | 452 |
| 38 | 424 | 394 | 408 | 548 | 488 | 396 | 462 | 424 | 422 | 478 | 410 | 458 | 444 |
| 39 | 424 | 394 | 408 | 548 | 488 | 396 | 462 | 424 | 422 | 478 | 410 | 458 | 444 |
| 40 | 424 | 394 | 408 | 548 | 488 | 396 | 462 | 424 | 422 | 478 | 410 | 458 | 444 |
| 41 | 398 | 368 | 382 | 522 | 462 | 370 | 436 | 398 | 396 | 452 | 384 | 432 | 418 |
| 42 | 518 | 488 | 502 | 642 | 582 | 490 | 556 | 518 | 516 | 572 | 504 | 552 | 538 |
| 43 | 440 | 410 | 424 | 564 | 504 | 412 | 478 | 440 | 438 | 494 | 426 | 474 | 460 |
| 44 | 432 | 402 | 416 | 556 | 496 | 404 | 470 | 432 | 430 | 486 | 418 | 466 | 452 |
| 45 | 396 | 366 | 380 | 520 | 460 | 368 | 434 | 396 | 394 | 450 | 382 | 430 | 416 |
| 46 | 462 | 432 | 446 | 586 | 526 | 434 | 500 | 462 | 460 | 516 | 448 | 496 | 482 |
| 47 | 383 | 353 | 367 | 507 | 447 | 355 | 421 | 383 | 381 | 437 | 369 | 417 | 403 |

| | R₁ | | | | | | | | | | | |
|---|---|---|---|---|---|---|---|---|---|---|---|---|
| R₂ | N | O | P | Q | R | S | T | U | V | W | X | Y |
| 0 | 368 | 361 | 427 | 353 | 403 | 397 | 354 | 318 | 320 | 444 | 334 | 292 |
| 1 | 454 | 447 | 513 | 439 | 489 | 483 | 440 | 404 | 406 | 530 | 420 | 378 |
| 2 | 523 | 516 | 582 | 508 | 558 | 552 | 509 | 473 | 475 | 599 | 489 | 447 |
| 3 | 507 | 500 | 566 | 492 | 542 | 536 | 493 | 457 | 459 | 583 | 473 | 431 |
| 4 | 389 | 382 | 448 | 374 | 424 | 418 | 375 | 339 | 341 | 465 | 355 | 313 |
| 5 | 443 | 436 | 502 | 428 | 478 | 472 | 429 | 393 | 395 | 519 | 409 | 367 |
| 6 | 465 | 458 | 524 | 450 | 500 | 494 | 451 | 415 | 417 | 541 | 431 | 389 |
| 7 | 440 | 433 | 499 | 425 | 475 | 469 | 426 | 390 | 392 | 516 | 406 | 364 |
| 8 | 440 | 433 | 499 | 425 | 475 | 469 | 426 | 390 | 392 | 516 | 406 | 364 |
| 9 | 457 | 450 | 516 | 442 | 492 | 486 | 443 | 407 | 409 | 533 | 423 | 381 |
| 10 | 543 | 536 | 602 | 528 | 578 | 572 | 529 | 493 | 495 | 619 | 509 | 467 |
| 11 | 439 | 432 | 498 | 424 | 474 | 468 | 425 | 389 | 391 | 515 | 405 | 363 |
| 12 | 518 | 511 | 577 | 503 | 553 | 547 | 504 | 468 | 470 | 594 | 484 | 442 |
| 13 | 405 | 398 | 464 | 390 | 440 | 434 | 391 | 355 | 357 | 481 | 371 | 329 |
| 14 | 461 | 454 | 520 | 446 | 496 | 490 | 447 | 411 | 413 | 537 | 427 | 385 |
| 15 | 405 | 398 | 464 | 390 | 440 | 434 | 391 | 355 | 357 | 481 | 371 | 329 |
| 16 | 495 | 488 | 554 | 480 | 530 | 524 | 481 | 445 | 447 | 571 | 461 | 419 |
| 17 | 473 | 466 | 532 | 458 | 508 | 502 | 459 | 423 | 425 | 549 | 439 | 397 |
| 18 | 403 | 396 | 462 | 388 | 438 | 432 | 389 | 353 | 355 | 479 | 369 | 327 |
| 19 | 445 | 438 | 504 | 430 | 480 | 474 | 431 | 395 | 397 | 521 | 411 | 369 |
| 20 | 445 | 438 | 504 | 430 | 480 | 474 | 431 | 395 | 397 | 521 | 411 | 369 |
| 21 | 431 | 424 | 490 | 416 | 466 | 460 | 417 | 381 | 383 | 507 | 397 | 355 |
| 22 | 459 | 452 | 518 | 444 | 494 | 488 | 445 | 409 | 411 | 535 | 425 | 383 |
| 23 | 417 | 410 | 476 | 402 | 452 | 446 | 403 | 367 | 369 | 493 | 383 | 341 |
| 24 | 529 | 522 | 588 | 514 | 564 | 558 | 515 | 479 | 481 | 605 | 495 | 453 |
| 25 | 499 | 492 | 558 | 484 | 534 | 528 | 485 | 449 | 451 | 575 | 465 | 423 |
| 26 | 499 | 492 | 558 | 484 | 534 | 528 | 485 | 449 | 451 | 575 | 465 | 423 |
| 27 | 419 | 412 | 478 | 404 | 454 | 448 | 405 | 369 | 371 | 495 | 385 | 343 |
| 28 | 457 | 450 | 516 | 442 | 492 | 486 | 443 | 407 | 409 | 533 | 423 | 381 |
| 29 | 457 | 450 | 516 | 442 | 492 | 486 | 443 | 407 | 409 | 533 | 423 | 381 |
| 30 | 457 | 450 | 516 | 442 | 492 | 486 | 443 | 407 | 409 | 533 | 423 | 381 |
| 31 | 419 | 412 | 478 | 404 | 454 | 448 | 405 | 369 | 371 | 495 | 385 | 343 |
| 32 | 391 | 384 | 450 | 376 | 426 | 420 | 377 | 341 | 343 | 467 | 357 | 315 |
| 33 | 469 | 462 | 528 | 454 | 504 | 498 | 455 | 419 | 421 | 545 | 435 | 393 |
| 34 | 469 | 462 | 528 | 454 | 504 | 498 | 455 | 419 | 421 | 545 | 435 | 393 |
| 35 | 483 | 476 | 542 | 468 | 518 | 512 | 469 | 433 | 435 | 559 | 449 | 407 |
| 36 | 453 | 446 | 512 | 438 | 488 | 482 | 439 | 403 | 405 | 529 | 419 | 377 |
| 37 | 453 | 446 | 512 | 438 | 488 | 482 | 439 | 403 | 405 | 529 | 419 | 377 |
| 38 | 445 | 438 | 504 | 430 | 480 | 474 | 431 | 395 | 397 | 521 | 411 | 369 |
| 39 | 445 | 438 | 504 | 430 | 480 | 474 | 431 | 395 | 397 | 521 | 411 | 369 |
| 40 | 445 | 438 | 504 | 430 | 480 | 474 | 431 | 395 | 397 | 521 | 411 | 369 |
| 41 | 419 | 412 | 478 | 404 | 454 | 448 | 405 | 369 | 371 | 495 | 385 | 343 |
| 42 | 539 | 532 | 598 | 524 | 574 | 568 | 525 | 489 | 491 | 615 | 505 | 463 |
| 43 | 461 | 454 | 520 | 446 | 496 | 490 | 447 | 411 | 413 | 537 | 427 | 385 |
| 44 | 453 | 446 | 512 | 438 | 488 | 482 | 439 | 403 | 405 | 529 | 419 | 377 |
| 45 | 417 | 410 | 476 | 402 | 452 | 446 | 403 | 367 | 369 | 493 | 383 | 341 |
| 46 | 483 | 476 | 542 | 468 | 518 | 512 | 469 | 433 | 435 | 559 | 449 | 407 |
| 47 | 404 | 397 | 463 | 389 | 439 | 433 | 390 | 354 | 356 | 480 | 370 | 328 |

Table 3 illustrates structures of R₁ groups in the triazine compounds produced according to the present invention. These structures are for purposes of illustration only, and not for limitation.

TABLE 3
Structures of R₁ Group.

| R₁ | Structure |
|---|---|
| A | 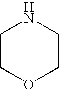 |
| B | 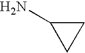 |
| C | 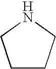 |
| D | 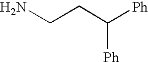 |
| E | 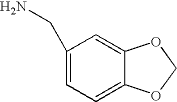 |
| F | 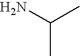 |
| G | 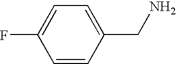 |
| H | 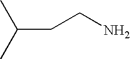 |
| I | 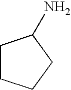 |
| J | 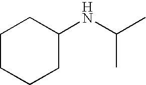 |
| K | 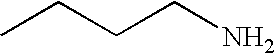 |
| L | 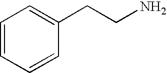 |
| M | 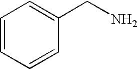 |
| N | 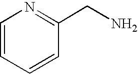 |
| O | 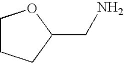 |
| P | 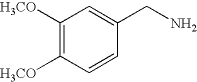 |
| Q | 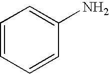 |
| R | 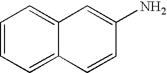 |
| S | 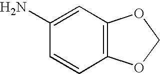 |
| T | 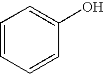 |
| U | 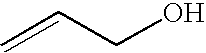 |
| V | 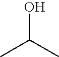 |
| W | 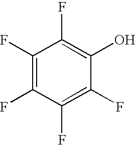 |
| X | 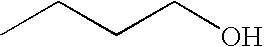 |
| Y | CH₃OH |

TABLE 3
Structures of R₂ Group.

| R₂ | Structure |
|---|---|
| 0 | Cl |
| 1 | 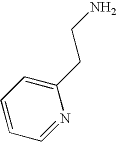 |
| 2 | 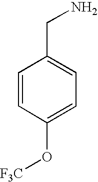 |
| 3 | 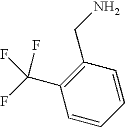 |
| 4 | 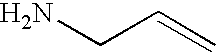 |
| 5 | 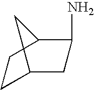 |
| 6 | 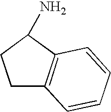 |
| 7 | 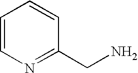 |
| 8 | 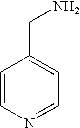 |
| 9 | 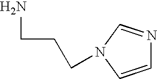 |
| 10 | 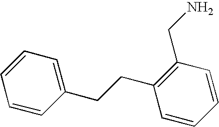 |
| 11 | 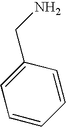 |
| 12 | 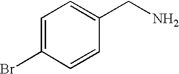 |
| 13 | 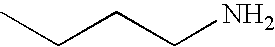 |
| 14 | 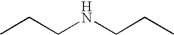 |
| 15 | 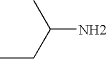 |
| 16 | 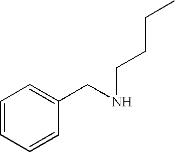 |
| 17 | 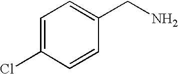 |
| 18 | 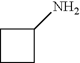 |
| 19 | 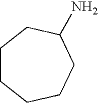 |
| 20 | 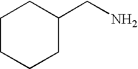 |
| 21 | 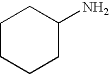 |
| 22 | 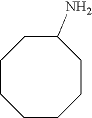 |
| 23 | 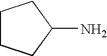 |
| 24 | 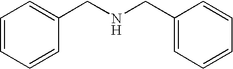 |
| 25 | 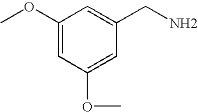 |
| 26 | 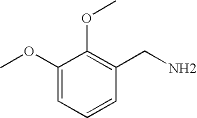 |
| 27 | 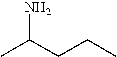 |
| 28 | 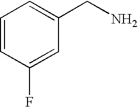 |
| 29 | 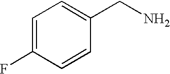 |
| 30 | 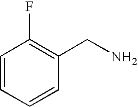 |
| 31 | 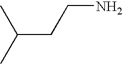 |
| 32 | 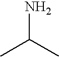 |
| 33 | 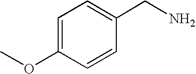 |
| 34 | 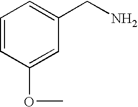 |
| 35 | 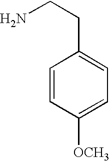 |
| 36 | 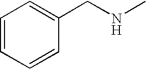 |
| 37 | 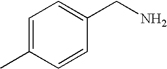 |
| 38 | 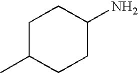 |
| 39 | 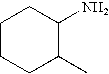 |
| 40 | 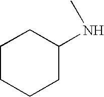 |
| 41 | 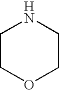 |
| 42 | 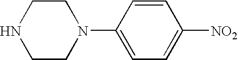 |
| 43 | 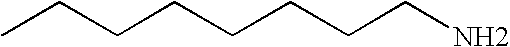 |
| 44 | 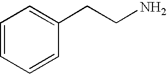 |
| 45 | 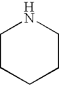 |
| 46 | 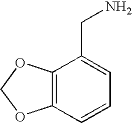 |
| 47 | 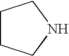 |

Generally, R₁ may be a C₁₋₁₄ alcohol or amino group, a C₁₋₁₄ alkyl group, phenyl substituted with at least one of F, Cl, methoxy, ethoxy, trifluoromethyl, or C₁₋₆ alkyl; or benzyl substituted with at least one of F, Cl, methoxy, ethoxy, trifluoromethyl, or C₁₋₆ alkyl. R₂ may be a C₁₋₁₄ amino group a C₁₋₁₄ alkyl group, phenyl substituted with at least one of F, Cl, methoxy, ethoxy, trifluoromethyl, or C₁₋₆ alkyl; or benzyl substituted with at least one of F, Cl, methoxy, ethoxy, trifluoromethyl, or C₁₋₆ alkyl.

### Agarose Bead Synthesis

In a 1 ml syringe cartridge (Ppcartridge with 20 m PE frit), 1 ml of Reacti-Gel 6X in acetone (purchased from Pierce), 10 ml of crosslinked agarose, 45-165 mm, >50 mmole/ml gel was added and 2 mL×10.1 M K₂CO₃ Reacti-Gel 6X in a 3 mL syringe cartridge was suspended with 1 mL of 0.1 M K₂CO₃. To this was added 100 mL (50 mM) in DMSO) triazine-linker compound with amine. The coupling buffer was removed and Tris buffer was added to block any excess reactive groups. The reaction mixture was washed twice with 10 mL H₂O and twice with 10 mL PBS.

### Application of Triazine Linker Library and Affinity Matrices

The triazine linker library molecules can be used in a variety of phenotypic assays to find interesting small molecules and their binding proteins in an expeditious way. These assays include Zebrafish embryo development, morphological changes in S-pombi, membrane potential sensing in cell systems, phenotypic screening in C-elenas, muscle regeneration in newt, tumorigenesis in brain cells, apoptosis and differentiation of cancer cells, cell migration and anti-angiogenesis. The active compounds are classified depending upon their ability to induce unique morphological changes, and these are then used for affinity matrix work.

Selected linker library molecules are loaded onto activated agarose beads via their amino-end linkers as described above. These affinity matrix beads are incubated with cell or tissue extract, and found proteins run on gel. The found proteins are analyzed using MS-MS sequencing after in-gel digestion to give the peptide sequences of the target protein.

The linker library molecules can be used for making a high density small molecule chip. Thousands of linker library molecules are immobilized on a glass slide by a spotting method, which can add hundreds to thousands or molecules to a slide. The amino end of the linker is connected to an activated functional group on the slide, such as isocyanate, isothiocyanate, or acyl imidazole. Fluorescent labeled proteins with different dyes are incubated with the slide. A scanner analyzes the color to give the absolute and relative binding affinity of different proteins on each compound. For example, no color means there is no activity with any kind of proteins. A strong mixed color means that the compounds are non-specifically active with multiple proteins. Exclusively stained compounds, with a singe color, indicate a selective bind of the relevant protein. Using this technique, thousands of small molecules can be tested in a shot time using a small amount of protein. In this approach, limited numbers of purified proteins compete with each other in the presence of multiple small molecules. This approach is analogous to DNA microarray technology, which has been important in advances in functional genomics. Although there have been some reports of protein chips 8, at yet no small molecule library chip has been demonstrated. Therefore, the small molecule chips of the present invention will offer totally new techniques in the field of chemical genetics, which will expand the study of the entire genome.

Immunoglobulins have seen numerous applications spanning immunoassays, diagnostics, and immunotherapeutics.1c The production of immunoglobulins, for example, valuable humanized variants, for therapeutic applications requires stringent purification measures before being administered as approved drugs. However high molecular weight ligands, such as staphylococcal protein A and streptococcal protein G, are unfavorable for medicinal applications for their potential pyogenic effect as well as for other problems, including low biological stability, leakage from solid support, and difficulty in large-scale production and purification, contributing to high overall cost.10 Recent literature has shown that triazines may prove useful small-molecule ligand alternatives to IgG. For example, Li et al. used compute raided molecular modeling to successfully identify triazene analogues that bind to IgG with affinity constants of 105-106 M-1.1c We thus hypothesized valuable potentials in screening human IgG against our arrays not only as proof of our overall concept but also in the discovery of efficacious ligands with direct relevance to industry.

Human IgG was fluorescently labeled with Cy3-NHS to allow for sensitive visualization of small molecule-IgG interactions on the array. Spotted slides alone, without incubation with labeled IgG, were also scanned to ensure that the fluorescence did not originate from the spotted compounds themselves. The resulting scans were typical to that seen in FIG. 1. Cases in which only one of the two duplicate spots displayed a substantive signal were dismissed as artifacts, and only hits that corroborated well in repeated experiments were deemed true positives. Three of the strongest hits on the array, based on intensity, were chosen for further validation, namely AMD10, AMD3, and K28. A faint positive, K42, and a negative, APF29, were also used as comparative benchmarks. In separate control experiments, other fluorescently labeled proteins (unrelated to human IgG) were used to screen against the same slide: none of the hits (e.g. AMD10, AMD3, K28, and K42) showed any positive binding, indicating that their binding toward human IgG is, indeed, highly specific. The spot intensities of these molecules are given in Table 1, with the background subtracted accordingly.

Dissociation constants were determined for each of the compounds selected using SPR on a Biacore X system with BiaEvaluation software. Competitive binding experiments were performed with differentially proportioned mixtures of a small molecule and protein A on a CM-5 chip immobilized with human IgG (see Supporting Information) (Table 1), which also ensures the small molecule binding to the same Scheme 2. General Experimental Scheme a (a) Directed immobilization of triazine libraries to generate a high-density microarray. (B) Incubation with a fluorescently labeled protein. (C) Removal of the unbound protein through washing. (D) Detection with instantaneous deconvolution of positive hits. (E) Assessing efficacy of hits using SPR. An averaged dissociation constant of 1.25×10−9 M was obtained for protein A with IgG alone. Further assessments made by passing 2.5 iM of a small molecule against the IgG surface were also performed to give measurable association levels that correlate with binding affinities (Table 1). Immobilizing the small molecules and applying IgG in the solution phase obtained equivalent binding measurements; however, by employing the competitive binding method described, a single chip surface may be used for screening against multiple potential small-molecule ligands, economizing the process. A φ2 value of <10 was obtained for all Kd measurements, denoting good statistical validity of the results obtained.

All three of the strong hits defined by the microarray screening were shown to give significant dissociation constants in the micromolar region with IgG. This relationship was further confirmed with a strong increase in response units (RU) when these three molecules were passed across an IgG-derivatized surface. AMD10, AMD3, and K₂₈ gave the strongest results with the lowest Kd values of 4.35×10−6, 2.02×10−6, and 2.02×10−6 M, respectively. These values were more than an order of magnitude lower than that of the secondary binder, K42, which was only weakly positive on the microarray screen. Expectedly, the negative control gave the weakest binding signals. These results further validate that tagging of the target protein with the dye for array applications did not perturb its binding properties with the small molecules. It is also interesting to note that the dissociation constant (e.g., Kd), as well as Koff (Supporting Information), of the hits as determined by SPR correlated well with their fluorescence intensity obtained from the microarray screening, with tight-binding compounds consistently giving stronger fluorescence spots. Overall, the dissociation constants obtained from the best hits identified in our experiments compare favorably with what was reported previously with other triazine-based small molecules.^{1c}

The present process provides a high-throughput screening system to detect small-molecule ligands for virtually any target and have shown its efficacy in discerning targets of a model protein, human IgG. The SMM used libraries of tagged triazine compounds, one of which is a novel library possessing a high degree of diversity and synthetic versatility. The tagged libraries intrinsically factor the linker in the screen, thus eliminating potential false negatives and increasing throughput. Further, we have developed a fully addressable microarray containing a few thousand compounds, with each compound, once being displayed as a positive, becoming immediately identifiable.

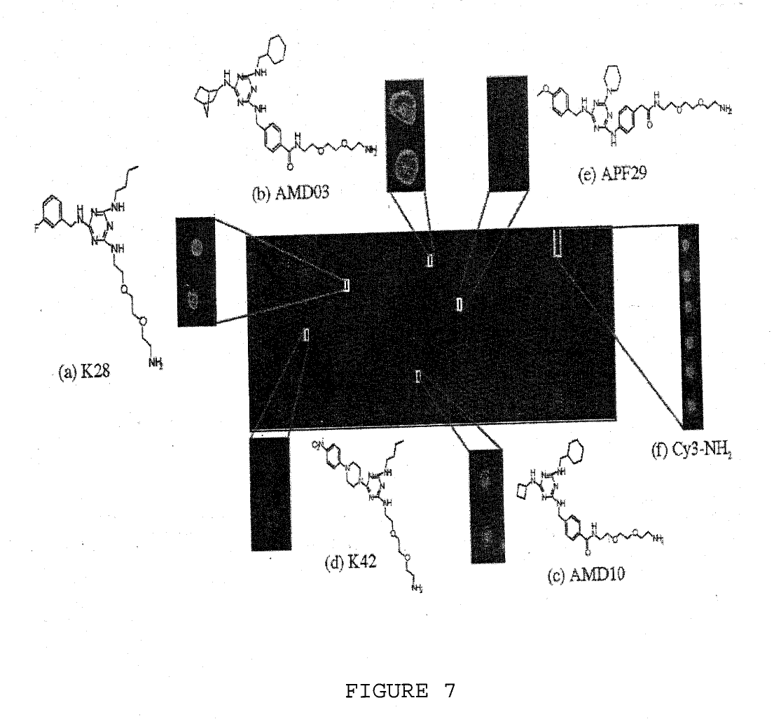

FIG. 7. NHS-derivatized slides with 2688 triazine compounds spotted in duplicates and probed with human IgG-Cy3. The actual-sized array is enclosed in a blue box, with blow-ups describing the loci and the corresponding molecules that were selected for further assessments. (a-c) Correlated with strongly positive molecules, producing spot intensities at least two times that of the background. An intermediate (d) and a negative control (e) were also picked for comparative assessment. The reference control (f) is shown, and four sets of the Cy3-NH2 dye were printed at the ends of the grids.

TABLE 4
Microarray and SPR Results Obtained with Five Selected Triazines

| | array signal | | |
|---|---|---|---|
| Small | (fluorescence | | |
| molecule | units) K_{d}/M ø2 | K_{d}/M | χ² |
| AMD10 | 179 (++) | 4.35 × 10⁻⁶ | 3.42 |
| AMD03 | 185 (++) | 2.02 × 10⁻⁶ | 2.32 |
| K28 | 143 (++) | 2.54 × 10⁻⁶ | 0.917 |
| K42 | 65 (+) | 6.02 × 10⁻⁵ | 2.19 |
| APF29 | <10 (−) | 1.51 × 10⁻⁴ | 4.02 |

solely by its position within the grid without the need for additional assessment. The IgG ligands discovered herein may soon find potential applications in the large-scale purification of immunoglobulins and would be useful alternatives to existing protein A-based isolation and purification systems. Studies are underway to establish the utility of the hits in this respect as well as work to identify further triazine ligands for other candidate proteins and DNA targets.

### Experimental Section

Materials Used. Unless otherwise noted, materials and solvents were obtained from commercial suppliers (Acros and Aldrich) and were used without further purifications. PAL-aldehyde (4-formyl-3,5-dimethoxyphenoxymethyl) resin from Midwest Bio-Tech (Catalogue No. 20840, Lot no. SY03470, loading level 1.10 mmol/g) was used for the generation of library compounds. Building block II compounds, made by solution phase chemistry, were purified by flash column chromatography on Sorbent Technologies silica gel, 60 Å (63-200 mesh). TLC was performed on SAI F254 precoated silica gel plates (250-im layer thickness). All library products were identified by an LC-MS at 250 nm (Agilent Technology, HP1100) using a C18 column (20×4.0 mm) with a gradient of 5-95% CH3CN—H2O (containing 0.1% acetic acid) as an eluent over 4 min.

Preparation of Triazine Libraries. The parallel syntheses of triazine libraries, excluding the TG library reported herein, and the synthesis of Boc-linker (2-[2-aminoethoxyethoxyethyl]carbamic tert-butyl ester), were previously published.

Preparation of TG Libraries. General Procedure for Coupling of the Linker onto the Resin (Scheme 1). To a solution of PAL-aldehyde resin (1.0 g, 1.1 mmol) was added Boc-linker (2-[2-aminoethoxyethoxyethyl]carbamic tert-butyl ester) (1.36 g, 5.5 mmol, 5 equiv) in THF (50 mL, containing 2% of acetic acid) at room temperature. The reaction mixture was stirred for 1 h at room temperature, followed by the addition of sodium triacetoxyborohydride (1.63 g, 7.7 mmol, 7 equiv). The reaction mixture was stirred for 12 h and filtered. The resin was washed with DMF (3 times), dichloromethane (3 times), methanol (3 times), and dichloromethane (3 times). The resin was dried in vacuo.

General Procedure for Building Block I. Cyanuric trichloride (1 equiv) was dissolved in THF with DIEA (10 equiv) at 0° C. The desired amine (1.2 equiv) in THF was added dropwise. For addition of alcohols to cyanuric chloride, the same reaction conditions were followed, except 2.5 equiv of K2CO3 was used instead of DIEA. The reaction mixture was stirred and monitored by TLC. Reaction time was 45 min to 1 h. A solid precipitate slowly formed. Upon completion of the reaction, the reaction mixture was quickly filtered through a plug of flash silica and washed with EA.

The filtrate was evaporated in vacuo. The resulting products were purified using flash column chromatography (particle size 32-63 mm) and characterized by LC-MS.

General Procedure for Coupling Building Block I with the Resin. Building block I (0.44 mmol) was added to the resin (0.11 mmol) in DIEA (1 mL) and anhydrous THF (10 mL) at room temperature. The reaction mixture was heated to 60° C. for 3 h and filtered. The resin was washed with DMF (5 times); alternatively with dichloromethane and methanol (5 times); and finally, with dichloromethane (5 times). The resin was dried in vacuo.

General Procedure for the Final Amination on the Resin and Product Cleavage Reaction. Desired amines (4 equiv) were added to the resin (10 mg), coupled with building block I and Boc linker, in DIEA (8 iL) and 1 mL of NMP/n-BuOH (1:1). The reaction mixture was heated to 120° C. for 3 h. The resin was washed with DMF (5 times); alternatively with dichloromethane and methanol (5 times); and finally, with dichloromethane (5 times). The resin was dried in vacuo. The product cleavage reaction was performed using 10% trifluoroacetic acid (TFA) in dichloromethane (1 mL) for 30 min at room temperature and washed with dichloromethane (0.5 mL). The purity and identity of all the products were monitored by LC-MS at 250 nm (Agilent 1100 model); more than 90% of compounds demonstrated >90% purity.

AMD03: ESI-MS (M+H)+calcd, 580.4; found, 581.6.

AMD10: ESI-MS (M+H)+calcd, 540.4; found, 541.5.

TGK28: ESI-MS (M+H)+calcd, 421.3; found, 422.5.

TGK42: ESI-MS (M+H)+calcd, 503.3; found, 504.5.

APF29: ESI-MS (M+H)+calcd, 578.3; found, 579.5.

Preparation and Analysis of Small-Molecule Arrays. Preparation of Slides Activated with N-Hydroxysuccinimide Esters. 2 Briefly, 25 mm×75 mm slides (Fisher Scientific) were cleaned in piranha solution (sulfuric acid/hydrogen peroxide, 7:3). An amine functionality was incorporated onto the slides by silanization using a solution of 3% (aminopropyl)triethoxysilane in 2% water and 95% ethanol. After 1-2 h of soaking, the slides were washed with ethanol and cured at 150° C. for at least 2 h. Subsequently, the amine slides were incubated in a solution of 180 mM succinic anhydride in DMF for 30 min thereafter were transferred to a boiling water bath for 2 min. The slides were washed again in ethanol and dried under a stream of nitrogen. The carboxylic acid moieties now created on the slide surface were activated with a solution of 100 mM of TBTU (O-(benzotriazol-1-yl)-N,N,N,N-tetramethyluronium tetrafluoroborate), 200 mM DIEA, and 100 mM N-hydroxysuccinimide in DMF, thus generating the NHS-derivatized slides.

The slides once generated were stored in a desiccator at −20° C. and used within 3 months.

Microarray Printing. By individually weighing the solid compounds, triazine stock solutions were prepared to 2.5 mM in DMF, and 40-iL preparations were distributed across seven 384-well plates to give a total of 2688 distinct and pure compounds. Slides were spotted on an ESI SMA arrayer (Ontario, Canada) with the printhead installed with eight ArrayIt Chipmaker 7 Microspotting pins (Telechem, U.S.A.). Printing was performed in duplicate, and the pins were washed and sonicated in ethanol between samples. A repotting blotting process was also performed on plain slides to ensure spot uniformity. An additional solution of 0.2 mM Cy3-NH2 11 reference was spotted at the ends of the grids using a final eighth plate.

After spotting, the slides were allowed to sit for at least 12 h in situ and then were quenched by washing in an 1% ethanolamine (in DMF) bath for 2 h. After rinsing with Journal of Combinatorial Chemistry Discovery of Small-Molecule Ligands of Human IgG E ethanol and drying, the arrayed slides were stored in a desiccator at 4° C. The slides were stable for extended periods and, when required, were simply brought to room temperature.

Protein Screening with Labeled Human IgG. Proteins were tagged with Cy3-NHS by incubating 5 iL of 20 mM Cy3-NHS (Amersham Biosciences, U.K.) with 200 ig of human IgG (Calbiochem, U.S.A.) in a sodium bicarbonate buffer at pH 8. After 1 h of incubation, the labeled protein was separated from the free dye by a NAP-5 Sephadex G-50 column (Amersham Biosciences, U.K.). Before incubation with the labeled protein, the slides were preblocked to remove any nonspecific binding by soaking in 1% BSA in PBS for 1 h. After a brief rinsing with water, the slides were incubated with the labeled IgG.

A 1000-fold dilution of the above protein preparation was used as the incubation solution in a PBS buffer containing 1% BSA with the small-molecule arrays using the cover slip method for 30 min in a humid incubation chamber. Excess IgG was then removed by washing with distilled water. The background was further reduced using repeated washes with PBST. Control screening experiments were performed with unrelated, fluorescently labeled proteins to ensure spots identified from the IgG experiment were highly specific.

Slide Scanning and Analysis. Slides were scanned on an ArrayWoRx scanner (Applied Precision, U.S.A.). Excel sheets were prepared to assign various compounds to specific numberings that could be readily tallied with reference numbers generated by the program. The ArrayWoRx software allows generation of reference files in which the spotting arrangement and the program overlay the spots on the results obtained, allowing compounds to be assigned in a rational fashion to every position. The software also provides large-scale analysis of hits, which rapidly analyzes the entire array, further enhancing throughput.

Surface Plasmon Resonance (SPR) Determination of Dissociation Constants. Maintenance. SPR measurements were made on a Biacore X system (Biacore AB, Uppsala, Sweden). Various maintenance steps were performed to ensure that the instrument was kept in good working conditions. The integrated flow cell was washed, sanitized, and maintained using standard cleansing reagents on a weekly basis. Calibration checks were performed quarterly to ensure that the signal was of good quality, and the instrument was kept separate from other equipments to prevent interference. When not in use, the system was docked with a spare chip and flushed with water at a low flow rate of 5 iL/min to prevent clogging. The system was primed at least twice before use or for the purpose of initiating a new buffer type. A desorb process was performed every 2 days during periods of active use to remove proteins or other contaminating compounds that may have accumulated within the flow cell.

Procedures. Various approaches were conceived to assess the Kd values of the interactions. One successful method immobilized the small molecule on the CM-5 sensor chips and ran them through varying concentrations of IgG. This was found to be a suitable but costly method, because it required multiple chips for analyzing the binding interactions of different small molecules. We conceived that it would be easier to immobilize IgG on the surface and apply differing proportioned mixtures of the “hit” small molecule and protein A (Amersham Biosciences, U.K.). The Heterogeneous Analyte Module of the BiaEvaluation software using this method worked efficiently in providing the required Kd values of the small molecules with IgG, allowing a single chip to be used repeatedly to assess different binding constants. Checks showed that up to 200 injections could be delivered on a single chip with negligible loss in signal output, with a regeneration buffer of dilute HCl, pH 2 (used throughout). Additionally, protein A was found not to bind to any of the small molecules that were tested. The presence of DMF in our small-molecule preparation was problematic in SPR measurements, because it perturbed the refractive index of the buffer, causing anomalous results. In our case, we overcame this problem by using a reference flow cell, thereby negating the effect of differing refractive indexes of the sample and buffer during sample introduction.

Immobilizing Samples on CM-5 Chips. The standard protocol supplied by the manufacturers was employed. The system was set to 25° C. and equilibrated with degassed HBS buffer (comprising 10 mM HEPES pH 7.4, 150 mM NaCl, 3 mM EDTA, and 0.005 v/v P20 surfactant). One flow cell was activated with 1:1 NHS/EDC for 8 min with a flow rate of 5 iL/min, while the other was kept as a reference.

After coupling IgG to give an immobilization increase of 5000 RU, the surface was quenched using 1 M ethanolamine, pH 9, for 7 min.

Determination of Association Levels of Small Molecule with IgG. Small-molecule preparations of 2.5 iM were passed through the IgG-activated flow cell with the reference automatically negating bulk effects. The flow rate used was 30 iL/min using PBS buffer, and 50 iL of each small molecule was applied over 1 min. The increase in response units observed directly tallied with small molecules that actively bound to the IgG-activated surface, thus providing a semiquantitative method to intercompare putative binders.

Determination of Dissociation Constants of Small Molecule with IgG. Twenty-five-microliter preparations of the small-molecule analytes (250 nM, 1 iM, 2 iM, 5 iM) were premixed with an equal volume of 238 nM of protein A and injected to the flow cell. The flow rate used was 30 iL/min with degassed PBS buffer. The results were entered into the BiaEvaluation module where the Heterogeneous Analyte Module was applied to obtain the binding and association constants required. Again, the reference cell was used to eliminate any bulk effects arising from the differing buffer composition.

Thus the use of microarrays of tagged combinatorial triazine libraries dramatically accelerates chemical genetics techniques by connecting phenotypic assay and affinity matrix work without any delay, rather than requiring months to years of SAR work. This powerful technique will revolutionize the study of the genome and will open a new field of chemical proteomics. Combining the binding protein data with a phenotype index will serve as a general reference of chemical knock-out. The present invention makes it possible to identify novel protein targets for drug development as well as drug candidates.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

### REFERENCES

1. Dhand, R. Ed., “Nature insight: Functional Genomics”, Nature, 2000, 405, 819-867.
2. (a) RNA interference: listening to the sound of silence, Zamore, P. D. Nat. Struct. Biol. 2001, 8, 746-750. (b) RNAi and brain function: was McConnell on the right track, Smalheiser, N. R.; Manev, H.; Costa, E. Trends Neurosci. 2001, 24, 216-218. (c) Gene silencing by double-stranded RNA, Carthew, R. W. Curr. Opin. Cell Biol. 2001, 13, 244-248. (d) A conserved mechanism for post-transcriptional gene silencing?, Maine, E. M. Genome Biol. 2000, 1, 1018. (e) High-throughput reverse genetics: RNAi screens in Caenorhabditis elegans, Bargmann, C. I. Genome Biol. 2001, 2, 1005. (f) Genome-wide RNAi, Barstead, R. Curr. Opin. Chem. Biol. 2001, 5, 63-66.
3. (a) Morpholino antisense oligomers: design, preparation, and properties, Summerton, J.; Weller, D. Antisense Nucl. Acid Develop. 1997, 7, 187-195. (b) Morpholino antisense oligomers: the case for an RNase H-independent structural type, Summerton, J. Biochim. Biophys. Acta 1999, 1489, 141-158. (c) RNA-based silencing strategies in plants, Matzke, M. A.; Matzke, A. J.; Pruss, G. J.; Vance, V. B. Curr. Opin. Genet. Dev. 2001, 11, 221-227.
4. (a) Chemical genetics resulting from a passion of synthetic organic chemistry, Schreiber, S. L. Bioorg. Med. Chem. 1998, 6, 1127-1152.
5. (a) Combinatorial Chemistry (Methods in Enzymology); Abelson, J. N. Ed.; Academic Press: New York, 1996. (b) Combinatorial Libraries-synthesis, screening and application potential; Cortese R. Ed.; Walter de Gruyter: Berlin, 1996. (c) Molecular Diversity and Combinatorial Chemistry: Libraries and Drug Discovery; Chaiken, I. M. and Janda, K. D. Ed.; American Chemical Society: New York, 1996. (d) Combinatorial Chemistry and Molecular Diversity in Drug Discovery; Gordon, E. M., Kerwin, J. F. Eds.; Wiley & Sons: New York, 1997. (e) Chemistry Synthesis and Application; Wilson, S. R., Czarnik, A. W. Eds.; Wiley & Sons: New York, 1997. (f) Combinatorial Peptide and Nonpeptide Libraried (a Handbook); Jung, G. Ed.; Wiley & Sons: New York, 1997. (g) A Practical Guide to Combinatorial Chemistry; Czarnik, A., DeWitt, S. Eds.; American Chemical Society, 1998. (h) Bunin, B. A. The Combinatorial Index; Academic Press: New York, 1998. (i) Terrett, N. K. Combinatorial Chemistry; Oxford University Press: Oxford, 1998. (j) Solid-Supported Combinatorial and Parallel Synthesis of Small-Molecular-Weight Compound Libraries; Obrecht, D., Villalgordo, J. M. Eds.; Pergamon: Netherlands, 1998. (k) Combinatorial Chemistry. Synthesis, Analysis, Screening; Jung G. Ed.; Wiley-VCH: Weinheim, 1999. (l) Dorwald, F. Z. Organic Synthesis on Solid Phase; Wiley-VCH: New York, 2000. (m) Seneci, P. Solid-Phase Synthesis and Combinatorial Technologies; Wiley & Sons: New York, 2000.
6. (a) Screening for novel antimicrobials from encoded combinatorial libraries by using a two-dimensional agar format, Silen J. L; Lu A. T.; Solas D. W.; Gore M. A.; MacLean D.; Shah N. H.; Coffin J. M.; Ehinderwala N. S.; Wang Y.; Tsutsui K. T.; Look G. C.; Campbell D. A.; Hale R. L.; Navre M.; DeLuca-Flaherty C. R. Antimicrob. Agents Chemother. 1998, 42, 1447-1453. (b) A strategy for the generation of biomimetic ligands for affinity chromatography. Combinatorial synthesis and biological evaluation of an IgG binding ligand, Teng, S. F.; Sproule, K.; Hussain, A.; Lowe, C. R. J. Mol. Recognit. 1999, 12, 67-75. (c) Design, synthesis and evaluation of biomimetic affinity ligands for elastases, Filippusson, H.; Erlendsson, L. S.; Lowe, C. R. J. Mol. Recognit. 2000, 13, 370-381.
7. (a) Incorporation of carbohydrates and peptides into large triazine-based screening libraries using automated parallel synthesis, Gustafson, G. R.; Baldino, C. M.; O'Donnel, M. E.; Sheldon, A. Tarsa, R. J.; Verni, C. J.; Coffen, D. L. Tetrahedron 1998, 54, 4051-4065. (b) Spatially Addressed Synthesis of Amino- and Amino-Oxy-Substituted 1,3,5-Triazine Arrays on Polymeric Membranes, Scharn, D.; Wenschuh, H.; Reineke, U.; Schneider-Mergener, J.; Germeroth, L. J. Comb. Chem. 2000, 2, 361-369. (c) Solution- and solid-phase synthesis of combinatorial libraries of trisubstituted 1,3,5-triazines, Masquelin, T.; Meunier, N.; Gerber, F.; Rosse, G. Heterocycles 1998, 48, 2489-2505. (d) Libraries of N-alkylamino heterocycles from nucleophilic aromatic substitution with purification by solid supported liquid extraction, Johnson, C. R.; Zhang, B.; Fantauzzi, P.; Hocker, M.; Yager, K. M. Tetrahedron 1998, 54, 4097-4106. (e) Library generation through successive substitution of trichlorotriazine, Stankova, M.; Lebl, M. Mol. Diversity. 1996, 2, 75-80.
8. Printing proteins as microarrays for high-throughput function determination, MacBeath, G.; Schreiber, S. L. Science 2000, 289, 1760-1763.
9. ArQule: Incorporation of Carbohydrates and Peptides into Large Triazine-Based Screening Libraries Using Automated Parallel Synthesis. Gustafson, G. R.; Baldino, C. M.; O'Donnel, M. E.; Sheldon, A. Tarsa, R. J.; Verni, C. J.; Coffen, D. L. Tetrahedron 1998, 54, 4051-4065.
10. Selectide Corporation: Library generation through successive substitution of trichlorotriazine. Stankova, M.; Lebl, M. Mol. Diversity. 1996, 2, 75-80.
11. Arris Pharmaceutical: Johnson, Charles R.; Zhang, Birong; Fantauzzi, Pascal; Hocker, Michael; Yager, Kraig M. Libraries of N-alkylamino heterocycles from nucleophilic aromatic substitution with purification by solid supported liquid extraction. Tetrahedron (1998), 54(16), 4097-4106. CODEN: TETRAB ISSN:0040-4020. CAN 128:308415 AN 1998:233899
12. Abbott: Hajduk, Philip J.; Dinges, Juergen; Schkeryantz, Jeffrey M.; Janowick, David; Kaminski, Michele; Tufano, Michael; Augeri, David J.; Petros, Andrew; Nienaber, Vicki; Zhong, Ping; Hammond, Rachel; Coen, Michael; Beutel, Bruce; Katz, Leonard; Fesik, Stephen W. Novel Inhibitors of Erm Methyltransferases from NMR and Parallel Synthesis. J. Med. Chem. (1999), 42(19), 3852-3859. CODEN: JMCMAR ISSN:0022-2623. CAN 131:308768 AN 1999:567005
13. Humboldt-Universitaet: Scharn, Dirk; Wenschuh, Holger; Reineke, Ulrich; Schneider-Mergener, Jens; Germeroth, Lothar. Spatially Addressed Synthesis of Amino- and Amino-Oxy-Substituted 1,3,5-Triazine Arrays on Polymeric Membranes. J. Comb. Chem. (2000), 2(4), 361-369. CODEN: JCCHFF ISSN:1520-4766. CAN 133:135605 AN 2000:355907
14. Hoffmann-La Roche: Masquelin, Thierry; Meunier, Nathalie; Gerber, Fernand; Rosse, Gerard. Solution- and solid-phase synthesis of combinatorial libraries of trisubstituted 1,3,5-triazines. Heterocycles (1998), 48(12), 2489-2505. CODEN: HTCYAM ISSN:0385-5414. CAN 130:196625 AN 1999:50090
15. Affymax: Silen J L; Lu A T; Solas D W; Gore M A; MacLean D; Shah N H; Coffin J M; Bhinderwala N S; Wang Y; Tsutsui K T; Look G C; Campbell D A; Hale R L; Navre M; DeLuca-Flaherty C R Screening for novel antimicrobials from encoded combinatorial libraries by using a two-dimensional agar format. ANTIMICROBIAL AGENTS AND CHEMOTHERAPY (1998 June), 42(6), 1447-53. Journal code: 6HK. ISSN:0066-4804. DN 98287588 PubMed ID 9624492 AN 1998287588
16. U. Cambridge: Teng, Su Fern; Sproule, Kenny; Hussain, Abid; Lowe, Christopher R. A strategy for the generation of biomimetic ligands for affinity chromatography. Combinatorial synthesis and biological evaluation of an IgG binding ligand. J. Mol. Recognit. (1999), 12(1), 67-75. CODEN: JMORE4 ISSN:0952-3499. CAN 131:30755 AN 1999:224014
17. U. Iceland: Filippusson, Horour; Erlendsson, Lyour S.; Lowe, Christopher R. Design, synthesis and evaluation of biomimetic affinity ligands for elastases. J. Mol. Recognit. (2000), 13(6), 370-381, 3 Plates. CODEN: JMORE4 ISSN:0952-3499. CAN 134:174701 AN 2000:857136
18. Closest in terms of biological activity and structure: Abbott 1: Henkin, Jack; Davidson, Donald J.; Sheppard, George S.; Woods, Keith W.; McCroskey, Richard W. Preparation of triazine-2,4-diamines as angiogenesis inhibitors. PCT Int. Appl. (1999), 66 pp. CODEN: PIXXD2 WO 9931088 A1 19990624 CAN 131:58855 AN 1999:404953
19. Abbott 2: Shock, Richard U. 2-[2-(5-Nitrofuryl)]-4,6-diamino-s-triazine. US 2885400 19590505 CAN 53:94898 AN 1959:94898
20. ArQule: Coffen, David L.; Hogan, Joseph C., Jr. Synthesis and use of biased arrays. PCT Int. Appl. (1998), 53 pp. CODEN: PIXXD2 WO 9846551 A1 19981022 CAN 129:302216 AN 1998:706192
21. Trustees of Boston University: Panek, James S.; Zhu, Bin. Synthesis of aromatic compounds by Diels-Alder reaction on solid support. PCT Int. Appl. (1998), 26 pp. CODEN: PIXXD2 WO 9816508 A2 19980423 CAN 128:308494 AN 1998:251157
22. ISIS Pharmaceuticals, Inc.: Cook, P. Dan; An, Haoyun. Preparation of Compounds or Combinatorial Libraries of compounds having a plurality of nitrogenous substituents. PCT Int. Appl. (1998), 187 pp. CODEN: PIXXD2 WO 9805961 A1 19980212 CAN 128:180338 AN 1998:112497
23. Hoffman-La Roche: Huber, Ulrich. Silanyl-triazines as light screening compositions. Eur. Pat. Appl. (1999), 26 pp. CODEN: EPXXDW EP 933376 A2 19990804 CAN 131:130123 AN 1999:505797

1. A high density chip comprising a surface onto which are linked tagged combinatorial trisubstituted triazine libraries, said triazine libraries.

2. The chip according to claim 1 wherein the triazines are linked to the surface with 2,2′-[1,2-ethanediyl-bus(oxy)]bismethanamine.

3. The chip according to claim 1 wherein the triazines are selected from compounds of the following formula: 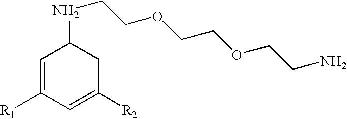
wherein R₁ is selected from the group consisting of 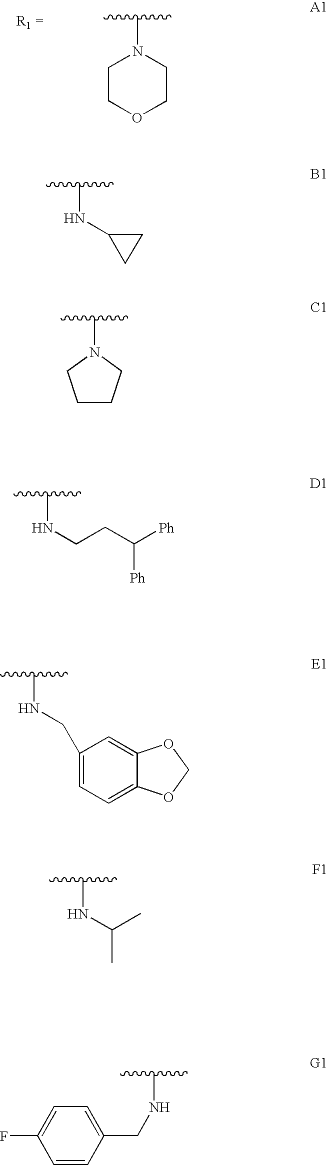 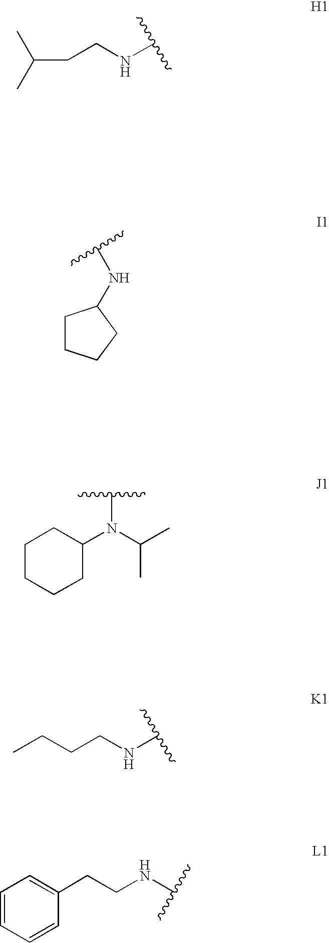 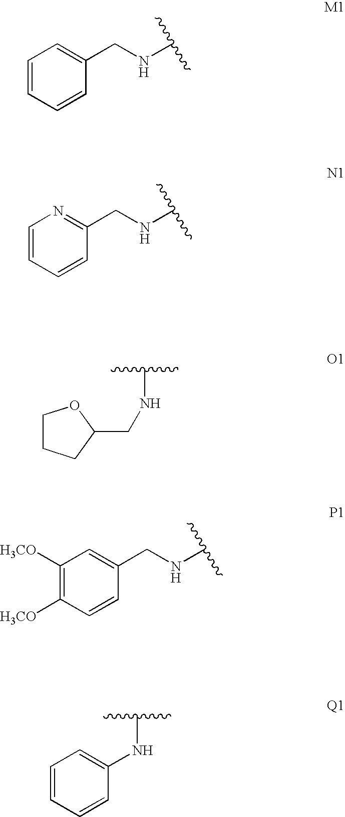 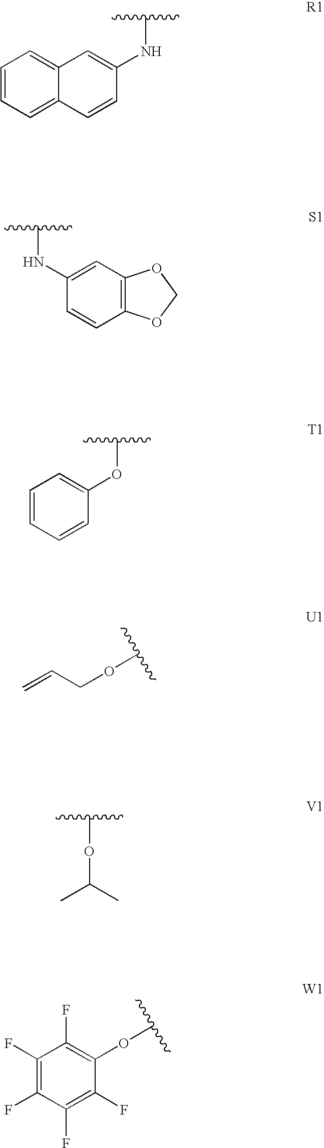 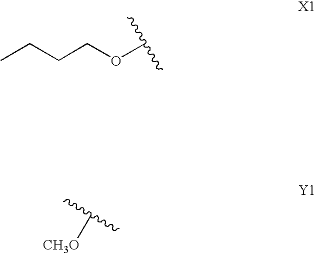
wherein R₂ is selected from the group consisting of NH₂, CH₃(C═O)NH— and CH₅(C═O)NH.

4. The chip according to claim 1 wherein the triazines are selected from compounds of the following formula: 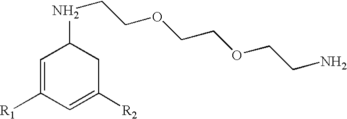
wherein R₁ is a C₁-C₁₄ alcohol group directly bound to the triazine ring via an oxygen atom or a C₁-C₁₄ amino group directly bound to the triazine ring via a nitrogen atom, and R₂ is a C₁-C₁₄ alkyl amine directly bound to the triazine ring via a nitrogen atom.

5. The chip according to claim 1 wherein the triazines are selected from the group consisting of:

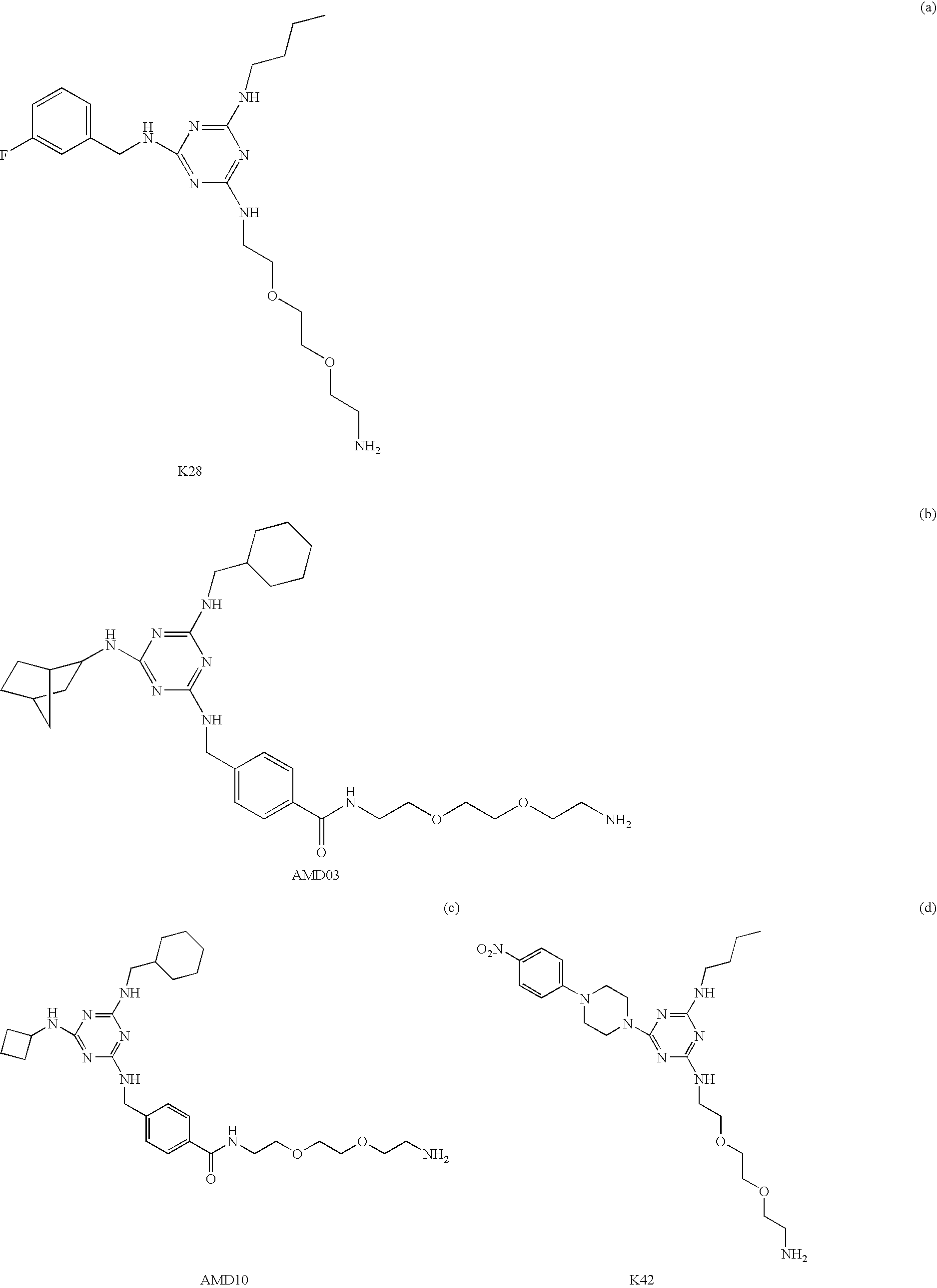

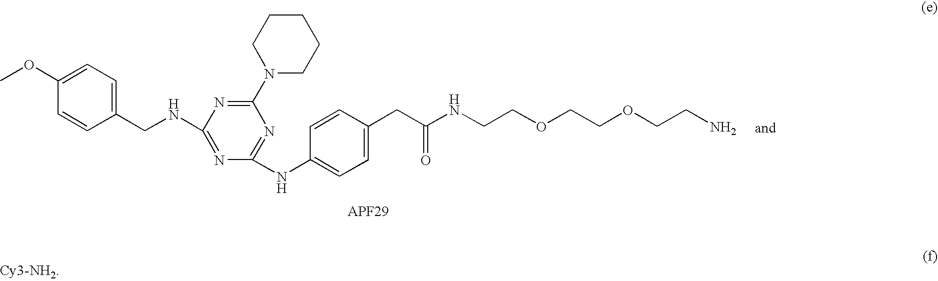

6. The chip according to claim 1 wherein the surface is a glass slide.

7. The chip according to claim 1 wherein the amino end of the linker is connected to an activated functional group on the surface of the chip.

8. The chip according to claim 6 wherein the activated functional group is selected from the group consisting of isocyanate, isothiocyanate, and acyl imidazole.

9. A method for determining the binding affinity of proteins to a plurality of molecules comprising incubating a high density small molecule ship according to claim 1 with a plurality of labeled proteins and analyzing the labels to determine which molecules have affinity for which proteins.

10. The method according to claim 8 wherein the label is a fluorescent label.
